(19) United States
(12) Patent Application Publication
(10) Pub. No.: US 2013/0039831 A1
(43) Pub. Date: Feb. 14, 2013

(54) METHOD OF PREPARING A HYDRIDOHALOSILANE COMPOUND

(71) Applicants: Aswini Dash, Midland, MI (US); Dimitris Katsoulis, Midland, MI (US)

(72) Inventors: Aswini Dash, Midland, MI (US); Dimitris Katsoulis, Midland, MI (US)

(21) Appl. No.: 13/563,866

(22) Filed: Aug. 1, 2012

Related U.S. Application Data
(63) Continuation-in-part of application No. PCT/US12/22001, filed on Jan. 20, 2012.
(60) Provisional application No. 61/435,829, filed on Jan. 25, 2011.

(51) Int. Cl. C01B 33/107

(52) U.S. Cl. 423/342

(57) ABSTRACT

A method of preparing a hydridohalosilane compound comprises treating a preformed metal silicide with a mixture comprising hydrogen gas and a silicon tetrahalide to prepare the hydridohalosilane compound.

### RELATED APPLICATIONS

This application is a continuation-in-part application of International Patent Application No. PCT/US12/022001, filed on Jan. 22, 2012, which claims priority to U.S. Provisional Patent Application Ser. No. 61/435,829, filed on Jan. 25, 2011.

### FIELD OF THE INVENTION

The present invention generally relates to method of preparing a hydridohalosilane compound and, more specifically, to a method of preparing a hydridohalosilane compound with a preformed metal silicide.

### DESCRIPTION OF THE RELATED ART

Hydridohalosilane compounds are well known in the art and are typically utilized to form crystalline or amorphous silicon via a deposition apparatus. For example, trichlorosilane, which is one species of hydridohalosilane compounds, may be utilized to form crystalline silicon, e.g. single-, multi-, and/or polycrystalline silicon, or amorphous silicon. The crystalline or amorphous silicon can then be utilized in various electronic applications, such as photovoltaic cell modules.

Conventional methods of preparing hydridohalosilane compounds are also known in the art. For example, one conventional method of preparing trichlorosilane includes the step of reacting elemental silicon with hydrochloric acid. However, this conventional method creates, in addition to the desired trichlorosilane, various undesirable by-products, such as silicon tetrachloride, hexachlorodisilane, and dichlorosilane. Further, these methods require, as a starting material, elemental silicon (typically in powder form), which is energy intensive and costly to prepare.

### SUMMARY OF THE INVENTION AND ADVANTAGES

The present invention provides a method of preparing a hydridohalosilane compound. The method comprises treating a preformed metal silicide with a mixture comprising hydrogen gas and a silicon tetrahalide to prepare the hydridohalosilane compound.

The method of the instant invention may be utilized to prepare various hydridohalosilane compounds from a silicon tetrahalide with a desirable yield. The hydridohalosilane compounds produced according to the method may be utilized in various known processes and applications.

### DETAILED DESCRIPTION OF THE INVENTION

The present invention provides a method of preparing a hydridohalosilane compound. The hydridohalosilane compound produced via the method may be utilized in diverse applications and methods. For example, the hydridohalosilane compound may be utilized to form crystalline silicon, e.g. single-, multi-, and/or polycrystalline silicon, or amorphous silicon. Alternatively, the hydridohalosilane compound may be utilized to form various silane compounds, organosilicon compounds, or silicone oligomers, gels, polymers, resins, etc., although the hydridohalosilane compound is not limited to such applications or methods.

In certain embodiments, the method comprises the step of activating a preformed metal silicide with hydrogen gas. The step of activating the preformed metal silicide may alternatively be referred to as pre-treating (or reacting) the preformed metal silicide.

The term “preformed,” as used herein with reference to the preformed metal silicide, means that at least a portion of the metal silicide is formed prior to the step of activating the preformed metal silicide with hydrogen gas. Alternatively, the entirety of the metal silicide may be preformed prior to the step of activating the preformed metal silicide with hydrogen gas.

The preformed metal silicide may have a variety of forms, shapes and sizes. For example, the preformed metal silicide may comprise various different metal silicides having different forms, shapes, and/or sizes. Alternatively, the preformed metal silicide may comprise but one preformed metal silicide having uniform dimensions. The preformed metal silicide may have a median diameter, which is used with reference to a greatest lateral dimension of the preformed metal silicide, in the nanometer scale, micrometer scale, millimeter scale, or centimeter scale. Most typically, the preformed metal silicide is finely-divided. The terminology “finely divided,” as used herein with reference to the preformed metal silicide, means that the preformed metal silicide is in the form of a powder, i.e., the performed metal silicide comprises particles or is in particulate form.

The preformed metal silicide comprises at least one metal, which is typically a transition metal. In certain embodiments, the at least one metal of the preformed metal silicide is selected from the group consisting of Co, Cr, Cu, Fe, Hf, Ir, Mn, Mo, Nb, Ni, Os, Pd, Pt, Re, Rh, Ru, Ta, Ti, V, W, Zr, and combinations thereof. Alternatively, the at least one metal of the preformed metal silicide is selected from at least one of Cu, Ni, Pd, and Pt. Alternatively, the at least one metal of the preformed metal silicide is selected from the group consisting of Cu, Pd, Pt, Ni, and combinations thereof. Alternatively, the at least one metal of the preformed metal silicide comprises Pd.

The preformed metal silicide typically has the general formula MₐSi_{b}, where M designates the at least one metal, and subscripts a and b are independently selected integers ≧1, typically from 1-10.

Specific examples of preformed metal silicides suitable for the instant method include, but are not limited to, PdSi, Pd₂Si, Pd₃Si, Pd₅Si, Pd₂Sig, NiSi, Ni₂Si, Ni₃Si, NiSi₂, Ni₃Si₂, Ni₃Si₂, Cu₃Si, Cu₅Si, PtSi, and Pt₂Si. In one embodiment, the preformed metal silicide is at least one of PdSi or Pd₂Si. The preformed metal silicide may comprise a mixture of different metal silicides.

The preformed metal silicide may be made by methods known in the art. For example, the preformed metal silicide may be made by mixing molten silicon and molten metal in the desired stoichiometric ratios and then cooling to temperatures known in the art to crystallize the desired preformed metal silicide. Once cooled and crystallized, the preformed metal silicide may be subjected to common methods for producing particulate metal from bulk metal ingots. For example, preformed metal silicide ingots may be subjected to attrition, impact, crushing, grinding, abrasion, milling, or chemical methods to produce a particulate preformed metal silicide. Grinding is a typical method of preparing the preformed metal silicide in particulate form. The preformed metal silicide may be further classified as to particle size distribution by means of, for example, screening or by the use of mechanical aerodynamic classifiers such as a rotating classifier. Other methods of making the preformed metal silicide known in the art are also contemplated for making the preformed metal silicide of the invention. For example, the methods of making palladium silicides disclosed in U.S. Pat. No. 3,297,403 and US 2009/0275466 may be utilized, the disclosures of which are herein incorporated by reference in their respective entireties. Many preformed metal silicides are available commercially from numerous suppliers. For example, some of the preformed metal silicides may be commercially obtained from Alfa Aesar and ACI Alloy.

When the method includes the step of activating the preformed metal silicide, the preformed metal silicide is typically activated with hydrogen gas in a reactor. For example, in one embodiment, the performed metal silicide is activated with hydrogen gas in a flow-through tube reactor. However, any vessel in which the performed metal silicide can be activated with hydrogen gas may be utilized in the method. For example, a sealed tube, an open tube, a fixed bed, a stirred bed, or a fluidized bed reactor may be utilized when activating the performed metal silicide.

The amount of the preformed metal silicide utilized in the reactor is typically at least 0.01, alternatively at least 0.5, alternatively from 1 to 10,000, mg catalyst/cm³ of reactor volume.

In certain embodiments, the step of activating the preformed metal silicide is carried out at a temperature of from 100 to 1000, alternatively from 300 to 700, alternatively from 350 to 650, alternatively from 400 to 600, alternatively from 450 to 550, ° C.

A pressure at which the preformed metal silicide is activated can be sub-atmospheric, atmospheric, or super-atmospheric. For example, the pressure is typically from 0 to 3500 kilopascals gauge (kPag); alternatively from 0 to 2000 kPag; alternatively from 0 to 1000 kPag; alternatively from 0 to 800 kPag. As used herein, 0 kPag means atmospheric pressure.

A flow rate of the hydrogen gas utilized to activate the preformed metal silicide is contingent on numerous factors, including the particular vessel in which the preformed metal silicide is disposed, the dimensions of the particular vessel, a time during which the hydrogen gas is utilized to activate the preformed metal silicide, and an amount of the preformed metal silicide to be activated. In various embodiments, the flow rate of hydrogen gas utilized to activate the preformed metal silicide is from greater than 0 to 100, alternatively from greater than 0 to 60, alternatively from 10 to 50, alternatively from 20 to 40, mL/min. These values for the flow rate of hydrogen gas are calculated based on the preformed metal silicide being present in the vessel (or reactor) in an amount of 0.5 grams per 23.5 cubic centimeters of reactor volume. To this end, these flow rates can be scaled up or down contingent on the volume of the vessel utilized.

Similarly, the time during which the hydrogen gas is utilized to activate the preformed metal silicide is contingent on numerous factors, including the particular vessel in which the preformed metal silicide is disposed, the dimensions of the particular vessel, the flow rate of the hydrogen gas, and an amount of the preformed metal silicide to be activated. In various embodiments, the time during which the hydrogen gas is utilized to activate the preformed metal silicide is from 30 to 180, alternatively from 60 to 150, alternatively from 70 to 140, minutes.

The flow rate of hydrogen gas and the time during which the hydrogen gas is utilized to activate the performed metal silicide are typically selected so as to provide a residence time sufficient for the hydrogen gas to contact and activate the preformed metal silicide. In certain embodiments, the residence time of the hydrogen gas is at least 0.01 seconds, alternatively at least 0.1 seconds, alternatively from 0.1 seconds to 10 minutes, alternatively from 0.1 seconds to 1 minute, alternatively from 0.5 to 10 seconds. The terminology “residence time,” as used herein with reference to the residence time of the hydrogen gas utilized to activate the preformed metal silicide, means the time for one reactor volume of hydrogen gas to pass through a reactor containing the preformed metal silicide. The residence time of the hydrogen gas may be selectively modified by adjusting the flow rate of the hydrogen gas.

In certain embodiments, the step of activating the preformed metal silicide with hydrogen gas is carried out in the absence of silicon tetrahalide. By “absence of silicon tetrahalide,” it is meant that silicon tetrahalide may be present in an amount of less than 0.5, alternatively less than 0.25, alternatively less than 0.1, alternatively less than 0.01, alternatively 0, moles per each mole of hydrogen gas utilized in the step of activating the preformed metal silicide.

Without being limited by theory, it is believed that the step of activating the preformed metal silicide with hydrogen gas removes any undesirable oxides that may be present along with the preformed metal silicide, which may be minimally present as a by-product from preparation of the preformed metal silicide. Further, dissociative adsorption/absorption of hydrogen gas may occur relative to the at least one metal or the silicon of the preformed metal silicide. Accordingly, although not require, the step of activating the preformed metal silicide generally improves yield of the hydridohalosilane compound in the method.

The method comprises the step of treating the preformed metal silicide with a mixture comprising hydrogen gas and silicon tetrahalide to prepare the hydridohalosilane compound.

The silicon tetrahalide has the general formula SiX₄, where X is independently selected from chloro, bromo, fluoro, or iodo. In certain embodiments, X is independently selected from chloro, bromo, or iodo. In one specific embodiment, each X is chloro.

Examples of the silicon tetrahalide include, but are not limited to, silicon tetrachloride, silicon tetrabromide, silicon tetraiodide, and silicon tetrafluoride. Alternatively, the silicon tetrahalide may include different halogen atoms within one molecule, and/or combinations of different silicon tetrahalides may be utilized in concert with one another.

Various silicon tetrahalide can be made by methods known in the art. Many of these silicon tetrahalides are available commercially from various suppliers.

The preformed metal silicide is typically treated with the mixture comprising the hydrogen gas and the silicon tetrahalide in a reactor, which may be the same as or different from the reactor utilized to activate the preformed metal silicide. For example, a sealed tube, an open tube, a fixed bed, a stirred bed, or a fluidized bed reactor may be utilized to treat the preformed metal silicide with the mixture.

In certain embodiments, the step of treating the preformed metal silicide is carried out at a temperature of from 300 to 1400, alternatively from 400 to 1200, alternatively from 600 to 1200, alternatively from 650 to 1100, ° C.

A pressure at which the preformed metal silicide is treated can be sub-atmospheric, atmospheric, or super-atmospheric. For example, the pressure is typically from 0 to 3500 kilopascals gauge (kPag); alternatively from 0 to 2000 kPag; alternatively from 0 to 1000 kPag; alternatively from 0 to 800 kPag.

The mixture typically comprises hydrogen gas and the silicon tetrahalide in a molar ratio of from 0.01 to 10,000, alternatively from 1 to 100, alternatively from 2 to 20. To this end, in certain embodiments, the mixture comprises a molar excess of the silicon tetrahalide relative to the hydrogen gas.

The mixture generally a residence time sufficient for the hydrogen gas and the silicon tetrahalide to contact the preformed metal silicide and form the hydridohalosilane compound. For example, the residence time of the mixture comprising the hydrogen gas and the silicon tetrachloride is typically at least 0.01 seconds, alternatively at least 0.1 seconds, alternatively from 0.1 seconds to 10 minutes, alternatively from 0.1 seconds to 1 minute, alternatively from 0.5 to 10 seconds. The terminology “residence time,” as used herein with reference to the residence time of the mixture comprising the hydrogen gas and the silicon tetrahalide utilized to treat the preformed metal silicide, means the time for one reactor volume of the mixture to pass through a reactor containing the preformed metal silicide. The residence time may be selectively modified by adjusting the flow rate of the mixture or the individual components within the mixture, i.e., the hydrogen gas and the silicon tetrahalide.

There is no upper limit on the time during which the preformed metal silicide is treated with the mixture. For example, the preformed metal silicide may be treated with the mixture for a time of at least 0.1 second, alternatively from 1 second to 5 hours, alternatively from 1 minute to 1.5 hours. However, once production of the hydridohalosilane compound reaches steady state, the preformed metal silicide may be treated in a continuous fashion contingent on a rate of depletion of silicon from the preformed metal silicide.

When a fluidized bed is utilized as the reactor for treating the preformed metal silicide, the mixture comprising the hydrogen gas and the silicon tetrahalide is introduced into the reactor bed at a rate sufficient to provide a residence time as described above but also at a rate sufficient to fluidize the bed. The rate will depend upon the particle size mass distribution of the particles of preformed metal silicide in the bed and the dimensions of the fluidized bed reactor.

The mixture may be introduced into the reactor as a preformed mixture, or the hydrogen gas and the silicon tetrahalide may be independently introduced into the reactor such that the mixture is formed in situ.

The amount of the preformed metal silicide in the reactor is typically identical to the amount of preformed metal silicide utilized in the step of activating the preformed metal silicide. Said differently, the preformed metal silicide is typically present in the reactor in an amount of at least 0.01, alternatively at least 0.5, alternatively from 1 to 10,000, mg catalyst/cm³ of reactor volume.

The order of addition of the hydrogen, the silicon tetrahalide and the preformed metal silicide is not critical. For example, typically, the reactor is charged with the preformed metal silicide, followed by activation of the preformed metal silicide by the hydrogen gas, followed by the introduction of the silicon tetrahalide. The hydrogen gas may be continuously introduced into the reactor during the step of activating the preformed metal silicide and during the step of treating the preformed metal silicide, i.e., after activating the preformed metal silicide, the silicon tetrahalide is introduced into the reactor without ever ceasing the flow of the hydrogen gas. At this time, the mixture of the hydrogen gas and the silicon tetrahalide is formed in situ as the silicon tetrahalide is introduced into the reactor. Alternatively, the preformed metal silicide may be disposed in a different reactor after its formation, or the flow of hydrogen gas may cease altogether such that the mixture is introduced at once into the reactor to treat the preformed metal silicide. The treatment of the preformed metal silicide by separate pulses of the mixture is also envisioned.

The method may further comprise pre-heating and gasifying the silicon tetrahalide by known methods prior to treating the preformed metal silicide with the mixture comprising the silicon tetrahalide and the hydrogen gas. Alternatively, the method may further comprise bubbling the hydrogen gas through liquid silicon tetrahalide to vaporize the silicon tetrahalide prior to contacting the preformed metal silicide with the mixture.

The method may further comprise recovering the hydridohalosilane compound produced. The hydridohalosilane may be recovered by, for example, removing gaseous hydridohalosilane from the reactor followed by isolation by distillation.

The step of treating the preformed metal silicide produces a treated metal silicide. The treated metal silicide typically comprises additional silicon compared to the preformed metal silicide (i.e., the untreated metal silicide). As used herein, “additional silicon” means the silicon deposited on the preformed metal silicide by treatment with the mixture comprising the silicon tetrahalide and the hydrogen gas. The amount of additional silicon on the preformed metal silicide typically depends upon the length of time the preformed metal silicide is treated with the mixture comprising the hydrogen gas and the silicon tetrahalide, with longer treatment times and higher temperatures depositing more silicon. For example, the treated metal silicide typically comprises at least 0.1 to 90% (w/w), alternatively from 1 to 20% (w/w), alternatively from 1 to 5% (w/w), based on the weight of the preformed metal silicide, of additional silicon. The amount of silicon in the preformed metal silicide and the treated metal silicide may be determined using inductively coupled plasma atomic emission spectroscopy (ICP-AES) and ICP mass spectrometry (ICP-MS).

The step of treating the preformed metal silicide produces the halosilane compound. The halosilane compound produced via the method may be a single halosilane compound or a blend or combination of different halosilane compounds.

In certain embodiments, the hydridohalosilane compound has the following general formula:

HₐSiX₍₄₋ₐ₎

wherein X is an independently selected halogen atom; and a is 1 or 2. The halogen atom represented by X may independently be chloro, bromo, fluoro, or iodo. In certain embodiments, X is independently selected from chloro, bromo, or iodo. In one specific embodiment, each X is chloro.

Most typically, the halosilane compound has the general formula above when subscript a is 1 and each X is a chlorine atom. In these embodiments, the hydridohalosilane compound may be referred to as trichlorosilane, which has the general formula HSiCl₃. As noted above, a combination of different hydridohalosilane compounds may be prepared via the method. To this end, an alternative hydridohalosilane compound that may be prepared in addition or alternatively to the trichlorosilane is dichlorosilane (H₂SiCl₂), which is represented by the general formula above when each X is chloro and subscript a is 2. However, it is to be appreciated that additional and/or different hydridohalosilanes may be produced contingent on the particular silicon tetrahalide employed in the method. For example, the method could produce trichlorosilane, dichlorosilane, trifluorosilane, and difluorosilane in combination with one another. Alternatively, the method could produce any one of these particular hydridohalosilane compounds.

It is generally preferable in the method to minimize the production of any hydridohalosilane compounds in which subscript a is equal to 2. Said differently, it is generally preferable to maximize the production of hydridohalosilanes represented by the general formula above where subscript a is 1. To this end, in certain embodiments, the hydridohalosilane compound prepared from the method is substantially free from any dihalosilane compounds, which may be any compounds containing two hydrogen atoms and two halogen atoms bonded to a single silicon atom. By “substantially free,” as used herein with reference to the hydridohalosilane compound being substantially free from any dihalosilane compounds, it is meant that dihalosilane compounds are present in the hydridohalosilane compound in an amount of less than 5, alternatively less than 4, alternatively less than 3, alternatively less than 2, alternatively less than 1, mole percent based on the total number of moles of silicon tetrachloride utilized in the method.

The preferred species of hydridohalosilane compounds, i.e., HSiX₃, may be prepared via the instant method with an excellent yield. For example, in certain embodiments, the yield of the preferred species of hydridohalosilane compound is at least 5, alternatively at least 15, alternatively at least 25, alternatively at least 35, alternatively at least 50, mole percent, based on the total moles of the silicon tetrahalide utilized in the step of treating the preformed metal silicide. Typically, the balance of the reaction product comprises the silicon tetrahalide utilized in the method in its unreacted state as opposed to other species or compounds, as well as gaseous HCl. This unreacted silicon tetrahalide may be reacted and reused in the method or may be recovered for other methods/applications (or even disposal).

The method of the present invention produces hydridohalosilane compounds that can be utilized in known methods and applications. For example, as introduced above, the hydridohalosilane compound may be utilized to form crystalline silicon, e.g. single-, multi-, and/or polycrystalline silicon, or amorphous silicon. Such silicon can be utilized in various applications in diverse industries, particularly in the photovoltaic cell module industry. Alternatively, the hydridohalosilane compound may be utilized to form various silane compounds, organosilicon compounds, or silicone oligomers, gels, polymers, resins, etc.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

Further, any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The following examples are intended to illustrate the invention and are not to be viewed in any way as limiting to the scope of the invention.

### EXAMPLES

The Examples below illustrate the method of the invention and the impact of varying certain process parameters, such as reactor temperatures, mole ratios of the hydrogen gas and the silicon tetrahalide in the mixture, the particular preformed metal silicide utilized, etc. In each example below, various samples were taken at time increments and analyzed to determine yield of the hydridohalosilane compound. Generally, all method parameters being equal, yield increases over time as the method reaches steady state.

### Example 1

0.5 grams of a preformed metal silicide (PdSi) is loaded into a flow-through, quartz tube reactor. The preformed metal silicide is activated with H₂ gas at 500 ° C. for 90.0 min. The H₂ has a flow rate of 30 mL/min during the step of activating the preformed metal silicide. A mixture comprising H₂ gas and SiCl₄ is fed into the preformed metal silicide bed at 850 ° C. to treat the preformed metal silicide. During this treatment process, production of a hydridohalosilane compound, i.e., HSiCl₃, is seen, as confirmed by GC/GC-MS analysis. Table 1 illustrates the results by performing the reaction at constant temperature with varying H₂/SiCl₄ flow ratios within the mixture over time. HSiCl₃ yields vary from 34% to 66%.

TABLE 1

| | Time | H2 flow | SiCl4 Bubbler | H2/SiCl4 | Reactor | Pressure | End Products Yield (Mole %) | |
|---|---|---|---|---|---|---|---|---|
| Run | (min) | (sccm) | Temp (C.) | Mole Ratio | Temp (C.) | (psig) | HSiCl3 | SiCl4 |
| 1 | 5 | 30 | 0 | 8.6 | 850 | 20 | 34.45 | 65.55 |
| 2 | 36 | 10 | 0 | 8.6 | 850 | 36 | 36.32 | 63.68 |
| 3 | 62 | 10 | 0 | 8.6 | 850 | 39 | 37.64 | 62.36 |
| 4 | 80 | 10 | 0 | 8.6 | 850 | 40 | 40.06 | 59.94 |
| 5 | 150 | 10 | 0 | 8.6 | 850 | 42 | 33.61 | 66.39 |
| 6 | 168 | 10 | 0 | 8.6 | 850 | 44 | 41.16 | 58.84 |
| 7 | 186 | 10 | 0 | 8.6 | 850 | 45 | 43.70 | 56.30 |
| 8 | 258 | 10 | 0 | 8.6 | 850 | 38 | 41.45 | 58.55 |
| 9 | 276 | 10 | 0 | 8.6 | 850 | 38 | 42.40 | 57.60 |
| 10 | 294 | 10 | −5 | 11.3 | 850 | 38 | 43.45 | 56.55 |
| 11 | 312 | 10 | −10 | 15 | 850 | 38 | 46.51 | 53.49 |
| 12 | 330 | 10 | −20 | 27 | 850 | 37 | 47.92 | 52.08 |
| 13 | 348 | 10 | −36 | 74.1 | 850 | 35 | 55.98 | 44.02 |
| 14 | 366 | 10 | −50 | 199.3 | 850 | 34 | 64.68 | 35.32 |
| 15 | 384 | 10 | −51 | 214.9 | 850 | 34 | 63.94 | 36.06 |
| 16 | 402 | 10 | −54 | 270.3 | 850 | 34 | 65.86 | 34.14 |

### Example 2

0.5 grams of a preformed metal silicide (PdSi) is loaded into a flow-through, quartz tube reactor. The preformed metal silicide is activated with H₂ gas at 500 ° C. for 90.0 min. The H₂ has a flow rate of 30 mL/min during the step of activating the preformed metal silicide. A mixture comprising H₂ gas and SiCl₄ is fed into the preformed metal silicide bed at a temperature ranging from 500 to 850° C. to treat the preformed metal silicide. During this treatment process, production of a hydridohalosilane compound, i.e., HSiCl₃, is seen, as confirmed by GC/GC-MS analysis. Table 2 illustrates the results by performing the reaction at a varying temperature within the reactor. HSiCl₃ yields vary from 0.06% to 44.3%.

TABLE 2

| | Time | H2 flow | SiCl4 Bubbler | H2/SiCl4 | Reactor | Pressure | End Products Yield (Mole %) | |
|---|---|---|---|---|---|---|---|---|
| Run | (min) | (sccm) | Temp (C.) | Mole Ratio | Temp (C.) | (psig) | HSiCl3 | SiCl4 |
| 1 | 5 | 30 | 0 | 8.6 | 850 | 20 | 26.80 | 73.20 |
| 2 | 36 | 10 | 0 | 8.6 | 850 | 36 | 32.26 | 67.74 |
| 3 | 62 | 10 | 0 | 8.6 | 850 | 39 | 38.24 | 61.76 |
| 4 | 80 | 10 | −4 | 10.7 | 850 | 40 | 41.69 | 58.31 |
| 5 | 106 | 10 | −6 | 12 | 850 | 36 | 42.02 | 57.98 |
| 6 | 127 | 10 | −5 | 11.3 | 850 | 36 | 40.71 | 59.29 |
| 7 | 150 | 10 | 0 | 8.6 | 850 | 42 | 40.53 | 59.47 |
| 8 | 186 | 10 | 0 | 8.6 | 500 | 45 | 0.07 | 99.93 |
| 9 | 204 | 10 | 0 | 8.6 | 500 | 42 | 0.06 | 99.94 |
| 10 | 222 | 10 | 0 | 8.6 | 600 | 37 | 0.06 | 99.94 |
| 11 | 240 | 10 | 0 | 8.6 | 600 | 28 | 0.11 | 99.89 |
| 12 | 258 | 10 | 0 | 8.6 | 700 | 38 | 1.21 | 98.79 |
| 13 | 276 | 10 | 0 | 8.6 | 700 | 38 | 1.23 | 98.77 |
| 14 | 294 | 10 | 0 | 8.6 | 800 | 38 | 43.47 | 56.53 |
| 15 | 312 | 10 | 0 | 8.6 | 800 | 38 | 44.30 | 55.70 |
| 16 | 330 | 10 | 0 | 8.6 | 850 | 37 | 43.16 | 56.84 |

### Example 3

0.5 grams of a preformed metal silicide (PdSi) is loaded into a flow-through, quartz tube reactor. The preformed metal silicide is activated with H₂ gas at 500° C. for 90.0 min. The H₂ has a flow rate of 30 mL/min during the step of activating the preformed metal silicide. A mixture comprising H₂ gas and SiCl₄ is fed into the preformed metal silicide bed at a temperature of 850 ° C. to treat the preformed metal silicide. During this treatment process, production of a hydridohalosilane compound, i.e., HSiCl₃, is seen, as confirmed by GC/GC-MS analysis. Table 3 illustrates the results by performing the reaction with varying H₂/SiCl₄ flow ratios within the mixture over time and with varying temperatures of the SiCl₄ in the mixture. HSiCl₃ yields vary from 30% to 47%.

TABLE 3

| | Time | H2 flow | SiCl4 Bubbler | H2/SiCl4 | Reactor | Pressure | End Products Yield (Mole %) | |
|---|---|---|---|---|---|---|---|---|
| Run | (min) | (sccm) | Temp (C.) | Mole Ratio | Temp (C.) | (psig) | HSiCl3 | SiCl4 |
| 1 | 366 | 10 | 21 | 2.6 | 850 | 18 | 30.92 | 69.08 |
| 2 | 384 | 10 | 21 | 2.6 | 850 | 24 | 34.27 | 65.73 |
| 3 | 402 | 10 | 21 | 2.6 | 850 | 27 | 36.32 | 63.68 |
| 4 | 420 | 10 | 10 | 4.9 | 850 | 9 | 33.09 | 66.91 |
| 5 | 438 | 10 | 9 | 5.2 | 850 | 8 | 32.60 | 67.40 |
| 6 | 456 | 10 | 10 | 4.9 | 850 | 8 | 32.26 | 67.74 |
| 7 | 474 | 10 | 0 | 8.6 | 850 | 7 | 35.29 | 64.71 |
| 8 | 492 | 10 | 0 | 8.6 | 850 | 8 | 35.22 | 64.78 |
| 9 | 510 | 10 | 0 | 8.6 | 850 | 8 | 35.63 | 64.37 |
| 10 | 528 | 10 | −20 | 27 | 850 | 6 | 41.71 | 58.29 |
| 11 | 546 | 10 | −20 | 27 | 850 | 6 | 41.42 | 58.58 |
| 12 | 564 | 10 | −38 | 84.8 | 850 | 6 | 43.26 | 56.74 |
| 13 | 582 | 10 | −38 | 84.8 | 850 | 6 | 47.36 | 52.64 |

### Example 4

0.57 grams of a preformed metal silicide (Cu₃Si) is loaded into a flow-through, quartz tube reactor. The preformed metal silicide is activated with H₂ gas at 500° C. for 120.0 min. The H₂ has a flow rate of 30 mL/min during the step of activating the preformed metal silicide. A mixture comprising H₂ gas and SiCl₄ is fed into the preformed metal silicide bed at a temperature of 750° C. to treat the preformed metal silicide. During this treatment process, production of a hydridohalosilane compound, i.e., HSiCl₃, is seen, in addition to a second hydridohalosilane compound, i.e., H₂SiCl₂, as confirmed by GC/GC-MS analysis. Table 4 illustrates the results by performing the reaction with varying H₂/SiCl₄ flow ratios within the mixture over time. HSiCl₃ yields vary from 16% to 28%.

TABLE 4

| | Time | H2 flow | SiCl4 Bubbler | H2/SiCl4 | Reactor | Pressure | End Products Yield (Mole %) | | |
|---|---|---|---|---|---|---|---|---|---|
| Run | (min) | (sccm) | Temp (C.) | Mole Ratio | Temp (C.) | (psig) | H2SiCl2 | HSiCl3 | SiCl4 |
| 1 | 5 | 10 | 14 | 3.9 | 750 | 9 | 0.90 | 25.71 | 73.39 |
| 2 | 15 | 10 | 14 | 3.9 | 750 | 8 | 1.14 | 28.32 | 70.54 |
| 3 | 26 | 10 | 14 | 3.9 | 750 | 8 | 1.12 | 27.82 | 71.06 |
| 4 | 34 | 10 | 14 | 3.9 | 750 | 8 | 0.99 | 26.18 | 72.83 |
| 5 | 42 | 10 | 20 | 2.8 | 750 | 8 | 0.40 | 18.83 | 80.77 |
| 6 | 50 | 10 | 20 | 2.8 | 750 | 8 | 0.32 | 16.85 | 82.83 |
| 7 | 58 | 10 | 20 | 2.8 | 750 | 8 | 0.30 | 16.38 | 83.32 |
| 8 | 66 | 10 | 20 | 2.8 | 750 | 9 | 0.28 | 16.14 | 83.58 |

### Example 5

0.80 grams of a preformed metal silicide (Pt₂Si) is loaded into a flow-through, quartz tube reactor. The preformed metal silicide is activated with H₂ gas at 500° C. for 120.0 min. The H₂ has a flow rate of 30 mL/min during the step of activating the preformed metal silicide. A mixture comprising H₂ gas and SiCl₄ is fed into the preformed metal silicide bed at a temperature of 850° C. to treat the preformed metal silicide. During this treatment process, production of a hydridohalosilane compound, i.e., HSiCl₃, is seen, in addition to a second hydridohalosilane compound, i.e., H₂SiCl₂, as confirmed by GC/GC-MS analysis. Table 5 illustrates the results by performing the reaction with varying H₂/ SiCl₄ flow ratios within the mixture over time. HSiCl₃ yields vary from 8% to 11%.

TABLE 5

| | Time | H2 flow | SiCl4 Bubbler | H2/SiCl4 | Reactor | Pressure | End Products Yield (Mole %) | | |
|---|---|---|---|---|---|---|---|---|---|
| Run | (min) | (sccm) | Temp (C.) | Mole Ratio | Temp (C.) | (psig) | H2SiCl2 | HSiCl3 | SiCl4 |
| 1 | 5 | 10 | 21 | 8.6 | 850 | 4 | 1.68 | 8.65 | 89.67 |
| 2 | 15 | 10 | 21 | 8.6 | 850 | 4 | 0.70 | 8.38 | 90.92 |
| 3 | 26 | 10 | 21 | 8.6 | 850 | 4 | 0.48 | 9.17 | 90.35 |
| 4 | 34 | 10 | 10 | 8.6 | 850 | 4 | 1.26 | 10.70 | 88.05 |

### Example 6

0.80 grams of a preformed metal silicide (Ni₂Si) is loaded into a flow-through, quartz tube reactor. The preformed metal silicide is activated with H₂ gas at 500° C. for 120.0 min. The H₂ has a flow rate of 30 mL/min during the step of activating the preformed metal silicide. A mixture comprising H₂ gas and SiCl₄ is fed into the preformed metal silicide bed at a temperature of 850° C. to treat the preformed metal silicide. During this treatment process, production of a hydridohalosilane compound, i.e., HSiCl₃, is seen, in addition to a second hydridohalosilane compound, i.e., H₂SiCl₂, as confirmed by GC/GC-MS analysis. Table 6 illustrates the results by performing the reaction with varying H₂/SiCl₄ flow ratios within the mixture over time. HSiCl₃ yields vary from 8% to 15%.

TABLE 6

| | Time | H2 flow | SiCl4 Bubbler | H2/SiCl4 | Reactor | Pressure | End Products Yield (Mole %) | | |
|---|---|---|---|---|---|---|---|---|---|
| Run | (min) | (sccm) | Temp (C.) | Mole Ratio | Temp (C.) | (psig) | H2SiCl2 | HSiCl3 | SiCl4 |
| 1 | 5 | 10 | 0 | 8.6 | 850 | 4 | 1.45 | 8.75 | 89.79 |
| 2 | 15 | 10 | 0 | 8.6 | 850 | 4 | 2.11 | 12.70 | 85.19 |
| 3 | 26 | 10 | 0 | 8.6 | 85 | 4 | 2.35 | 14.88 | 82.77 |

### Comparative Example 1

A flow-through, quartz tube reactor that is free from any metal silicide is fitted with a glass wool plug and heated at 500° C. under H₂ for 30 minutes. The H₂ has a flow rate of 10 mL/min. A mixture comprising H₂ gas and SiCl₄ is fed the flow-through quartz tube reactor at a temperature of from 500 to 850° C. at different molar ratios of H₂ gas and SiCl₄. During this process, gas phase production of a hydridohalosilane compound, i.e., HSiCl₃, is seen, as confirmed by GC/GC-MS analysis. Table 7 illustrates the results by performing the reaction with varying H₂/SiCl₄ flow ratios within the mixture over time. HSiCl₃ yields vary from 0% to 45.69%.

TABLE 7

| | Time | H2 flow | SiCl4 Bubbler | H2/SiCl4 | Reactor | Pressure | End Products Yield (Mole %) | |
|---|---|---|---|---|---|---|---|---|
| Run | (min) | (sccm) | Temp (C.) | Mole Ratio | Temp (C.) | (psig) | HSiCl3 | SiCl4 |
| 1 | 21 | 10 | 21 | 2.6 | 800 | 13 | 8.37 | 91.63 |
| 2 | 41 | 10 | 21 | 2.6 | 850 | 13 | 20.57 | 79.43 |
| 3 | 60 | 10 | 21 | 2.6 | 850 | 14 | 20.83 | 79.17 |
| 4 | 75 | 10 | 0 | 8.6 | 850 | 11 | 28.25 | 71.75 |
| 5 | 90 | 10 | 0 | 8.6 | 850 | 11 | 28.39 | 71.61 |
| 6 | 120 | 10 | 0 | 8.6 | 850 | 11 | 29.58 | 70.42 |
| 7 | 140 | 10 | −20 | 27 | 850 | 8 | 34.70 | 65.30 |
| 8 | 155 | 10 | −20 | 27 | 850 | 8 | 35.70 | 64.30 |
| 9 | 180 | 10 | −40 | 97.2 | 850 | 7 | 41.60 | 58.40 |
| 10 | 192 | 10 | −40 | 97.2 | 850 | 7 | 45.69 | 54.31 |
| 11 | 212 | 10 | −50 | 199.3 | 850 | 7 | 43.90 | 56.10 |
| 12 | 225 | 10 | −50 | 199.3 | 850 | 7 | 43.44 | 56.56 |
| 13 | 237 | 10 | 21 | 2.6 | 500 | 7 | 0.00 | 100.00 |
| 14 | 249 | 10 | 0 | 8.6 | 500 | 7 | 0.00 | 100.00 |
| 15 | 261 | 10 | 0 | 8.6 | 500 | 7 | 0.00 | 100.00 |
| 16 | 273 | 10 | 0 | 8.6 | 600 | 7 | 0.04 | 99.96 |
| 17 | 285 | 10 | 0 | 8.6 | 700 | 7 | 0.42 | 99.58 |
| 18 | 297 | 10 | −3 | 10.1 | 800 | 7 | 11.63 | 88.37 |
| 19 | 309 | 10 | 0 | 8.6 | 800 | 7 | 11.64 | 88.36 |

The invention has been described in an illustrative manner, and it is to be understood that the terminology which has been used is intended to be in the nature of words of description rather than of limitation. Obviously, many modifications and variations of the present invention are possible in light of the above teachings. The invention may be practiced otherwise than as specifically described.

1. A method of preparing a hydridohalosilane compound, said method comprising treating a preformed metal silicide with a mixture comprising hydrogen gas and a silicon tetrahalide to prepare the hydridohalosilane compound.

2. A method as set forth in claim 1 further comprising the step of activating the preformed metal silicide with hydrogen gas prior to the step of treating the preformed metal silicide.

3. A method as set forth in claim 2 wherein the step of activating the preformed metal silicide with hydrogen gas is carried out in the absence of any silicon tetrahalide.

4. A method as set forth in 2 wherein the step of activating the preformed metal silicide is carried out at a temperature of from 200 to 1000° C.

5. A method as set forth in claim 2 wherein the hydrogen gas has a residence time from of from 0.5 to 10 seconds in the step of activating the preformed metal silicide.

6. A method as set forth in claim 1 wherein the step of treating the preformed metal silicide is carried out at a temperature of from 300 to 1400° C.

7. A method as set forth in claim 1 wherein the step of treating the preformed metal silicide is carried out at a temperature of from 650 to 1100° C.

8. A method as set forth in claim 1 wherein the hydridohalosilane compound has the following general formula:
HₐSiX₍₄₋ₐ₎
wherein X is an independently selected halogen atom; and
a is 1 or 2.

9. A method as set forth in claim 1 wherein the mixture comprises hydrogen gas and the silicon tetrahalide in a molar ratio of from 1.0 to 100.

10. A method as set forth in claim 1 wherein the preformed metal silicide comprises at least one metal selected from the group consisting of Co, Cr, Cu, Fe, Hf, Ir, Mn, Mo, Nb, Ni, Os, Pd, Pt, Re, Rh, Ru, Ta, Ti, V, W, Zr, and combinations thereof.

11. A method as set forth in claim 1 wherein the preformed metal silicide is selected from the group of PdSi, Pd₂Si, and combinations thereof.

12. A method as set forth claim 1 wherein the mixture comprising hydrogen and the silicon tetrahalide has a residence time from of from 0.5 to 10 seconds in the step of treating the preformed metal silicide.

13. A method as set forth in claim 1 having a yield of the hydridohalosilane compound of at least 5 mole % based on the total moles of the silicon tetrahalide utilized in the step of treating the preformed metal silicide.

14. A method as set forth in claim 1 having a yield of the hydridohalosilane compound of at least 50 mole % based on the total moles of the silicon tetrahalide utilized in the step of treating the preformed metal silicide.

15. A method of preparing trichlorosilane, said method comprising the steps of:
activating a preformed metal silicide at a temperature of from 200 to 1000° C. with hydrogen gas; and
treating the preformed metal silicide 300 to 1400° C. with a mixture comprising hydrogen gas and silicon tetrachloride to prepare the trichlorosilane.
